(19) United States
(12) Patent Application Publication
(10) Pub. No.: US 2013/0229448 A1
(43) Pub. Date: Sep. 5, 2013

(54) DISPLAY DEVICE FOR DISPLAYING STEREOSCOPIC IMAGES

(71) Applicant: INFITEC GMBH, Ulm (DE)

(72) Inventors: Arnold SIMON, Neu-Ulm (DE); Helmut JORKE, Gerstetten (DE)

(73) Assignee: INFITEC GMBH, Ulm (DE)

(21) Appl. No.: 13/746,783

(22) Filed: Jan. 22, 2013

Related U.S. Application Data
(63) Continuation of application No. PCT/EP2011/062280, filed on Jul. 18, 2011.

(30) Foreign Application Priority Data
Jul. 19, 2010 (DE) DE102010031534.6

(51) Int. Cl. G09G 5/14

(52) U.S. Cl. CPC G09G 5/14
USPC 345/697; 345/87

(57) ABSTRACT

A display device for displaying stereoscopic images is provided, wherein partial stereoscopic images are generated in spectral ranges at least partially different from each other, and wherein narrow-band emitting emission elements are present for generating images, and wherein different emission elements are present for generating spectrally narrow-band optical radiation in different spectral ranges, of which at least one comprises a light-converting material excited by an excitation element for emitting optical radiation.

This nonprovisional application is a continuation of International Application No. PCT/EP2011/062280, which was filed on Jul. 18, 2011, and which claims priority to German Patent Application No. DE 10 2010 031 534.6, which was filed in Germany on Jul. 19, 2010, and which are both herein incorporated by reference.

### BACKGROUND OF THE INVENTION

1. Field of the Invention

The present invention relates to a display device for displaying stereoscopic images.

2. Description of the Background Art

Display devices can be realized, for example, in that to create a three-dimensional impression in the viewer partial images are generated for the right or left eye; for the reconstruction of the three-dimensional image, the viewer wears glasses that selectively allow only the right partial image to pass for the right eye and only the left partial image for the left eye. This desired selection can be achieved, for example, in a time-division multiplexing method with so-called “shutter glasses” or also with the use of the polarization of light by generating different partial polarized images and the use of polarization filters in the mentioned glasses.

In addition, an approach is known from the conventional art in which the partial images are generated in different spectral ranges and the specific selection of the partial images for the respective eye is achieved by means of filter glasses, whereby the filter glasses are matched to the spectral characteristics of the partial images for the left or right eye by the use of matched spectral images for the particular eye. In particular, interference filters, which are formed for spectrally sharp filtering by a plurality of successive dielectric layers with a periodically changing refractive index, can be used both for generating partial images and for eye-selective filtering. The generation of partial images with their specific spectral characteristics with interference filters, as shown, for example, in European patent No. EP 1 101 362 B1, which corresponds to U.S. Pat. No. 7,001,021, and which has a number of disadvantages. In particular, during the generation of partial images with interference filters, a precise orientation of a typically broadband light source relative to the interference filters is necessary, to assure the spectral purity of the light used for image generation and thereby to prevent crosstalk of the individual partial images among one another. In addition, the filtering out of broad parts of a broadband spectrum occurs at the expense of image brightness.

An alternative to the use of interference filters for image generation is the use of narrowband light sources such as, for example, lasers. This variant is disclosed in German patent No. DE 198 08 264 C2, which is incorporated herein by reference. The generation of the six narrowband spectral ranges typically necessary for image display in this case requires the use of six different lasers.

### SUMMARY OF THE INVENTION

It is therefore an object of the present invention to provide a display device, in which the optical radiation used for image display can be generated with high spectral power density and at controllable cost.

In an embodiment, a display device is provided for displaying stereoscopic images that generate partial stereoscopic images in spectral ranges at least partially different from one another. In this regard, narrowband emitting emission elements for image generation are present, whereby different emission elements, at least one of which contains a light-converting material excited by an excitation element for emitting optical radiation, are present for generating spectrally narrowband optical radiation in different spectral ranges. In other words, the narrowband optical radiation, used for image generation, is generated at least partially not with the use of interference filters or a laser, but in that a light-converting material, a so-called phosphor, is excited by external excitation to emit narrowband optical radiation. In this way, on the one hand, a high spectral power density and, on the other, a structurally simplified solution is achieved, because in the extreme case the use of optical filters can be omitted.

“Narrowband optical radiation” can be understood here to be radiation which is sufficiently spectrally narrowband for imaging a two-dimensional color image. In contrast to broadband light sources according to the state of the art, the spectral light yield of the system increases, as already noted, by adjustment of the light source (peaks).

It was not possible thus far with the use of narrowband emitters (LEDs), with the exception of lasers, to offer a technical solution for the 3D visualization with wavelength multiplex technology without additional interference filters, because the emission of the LEDs was still too broad. The spectrum of the LEDs can be described approximately by a Gauss curve. In order to display a high-quality three-dimensional image, the crosstalk between the right and left partial image should be less than 1%. For use of spectral Gaussian emitters in which over 95% (2 sigma) of the spectral emission is to be used and whose spectral crosstalk in adjacent channels is to be less than 1%, the distance of the transmission peaks should be at least 3 sigma. The width of two transmission ranges and their distance is 9 sigma. In the case of the green range, a sigma of about 6.7 nm should result for the key data of 500-560 nm as a usable range. The conversion “full width at half maximum” (FWHM)=approximately 2.4 sigma thereby produces, for example, a maximum value of 15 nm FWHM for green, for example. As a rule, this value should be corrected further by the drift of the interference filters by oblique viewing angles, so that FWHM is greatly reduced further.

The emission of narrowband optical radiation within the necessary different spectral ranges can be achieved according to the teaching of the invention in particular in that at least two different emission elements are assigned similar excitation elements for optical excitation of the emission elements. The different spectral ranges can be achieved, for example, by the use of different phosphors, which are excited to emit light by means of a common source as an excitation element.

The excitation elements can be suitable in particular for emitting optical radiation to excite the optical emission elements. For example, the excitation elements can be realized as LEDs, which can be integrated in a simple way on a semiconductor chip.

For example, a UV-LED can be used as an excitation element, which emits optical radiation of a shorter wavelength than the emission element whose emission spectrum is typically within the visible spectral range.

Because at least one emission element contains a nanomaterial, for example, quantum dot nanoparticles, a narrowband emission of a special spectral purity can be achieved. Typical values here for the green spectral range are in the range of approximately 20-30 nm. The aforementioned materials are currently offered on the market as CdSe—ZnSe or CdS nanoparticles. Emission peak wavelengths of 380 nm to 640 nm are available, whereby wavelengths outside this range are also feasible in principle. The typical half-widths depending on production are <30 nm (FWHM) for CdS and <40 nm for CdSe—ZnSe. In principle, however, much smaller half-widths can be achieved.

It is advantageous when thermally relatively sensitive nanomaterials are used, for the excitation element and the emission element to be arranged at a distance from one another. The thermal load originating from the excitation element on the emission element is reduced as a result; moreover, structurally broader options for the arrangement of the emission elements become available.

In addition, it is also possible, in the case of integration on a common chip, that the excitation element and the emission element are in direct contact. For example, a compact, integrated microdisplay can be formed by this measure.

Because the emission element is arranged on a dichroic mirror, on the one hand, orientation of the emitted radiation in the desired direction and simultaneously additional spectral filtering can be achieved. To this end, the mirror preferably can transmit the light emitted by the excitation elements and preferably reflect the light emitted by the emission elements.

In addition, the mirror can reflect the light emitted by the excitation elements and preferably transmit the light emitted by the emission elements.

A directly emitting display device can be realized in a variant of the invention in that the emission elements themselves are formed at least partially as pixels or subpixels of a display.

To this end, the display device can have at least one substrate with a plurality of LEDs arranged on the substrate and at least one part of the emission elements assigned to the LEDs. Narrowband optical radiation in the visible blue, visible green, and visible red spectral ranges can be emitted by the pixels or subpixels, whereby there are two emission bands for each of the mentioned spectral ranges. It is possible in this way to generate in parallel on a common chip the two partial images of a stereoscopic image, which subsequently can be made available by means of suitable filter glasses selectively for the right or the left eye of a viewer.

An alternative embodiment of the invention results in that the pixels or subpixels are arranged on different substrates and the pixel images arising on the substrates are superimposed by means of an optical superposition unit. This variant, for example, can achieve that fewer different phosphors need to be used as light-converting material per employed substrate, so that the production of the substrate with the emission elements arranged thereupon becomes simpler.

An alternative display device can also be realized in that it has a projection unit for generating an image and at least one emission element is arranged on a color wheel. In this case, the desired stereo image can be achieved, for example, in that the rotating color wheel is arranged in the light path between a projection light source and a projection screen and partial images in different spectral ranges are generated successively.

Furthermore, the display device can be an LCD display, whereby at least one part of the emission elements is formed as part of a lighting unit for backlighting the LCD display.

In an embodiment of the invention, an emission element is located on the entry or exit surface of a light guide, with which homogeneous backlighting of the LCD display can be achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an arrangement in which an excitation element is in direct physical contact in an emission element;

FIG. 2 shows a variant in which the emission element is formed at a distance from excitation element;

FIG. 3 shows another variant in which two emission elements and are made of different materials;

FIG. 4 shows a variant of FIG. 3;

FIG. 5 shows an arrangement of six different emission elements on a common substrate;

FIGS. 6A and 6B show an exemplary application of the solutions presented in FIGS. 1 through 5;

FIG. 7 shows a display device with use of the components shown in FIG. 6;

FIG. 8 shows an embodiment in which the emission elements for all spectral lines are arranged on a common substrate:

FIG. 9 shows an LCD display 30 in which another variant of the invention is used;

FIGS. 10A-10D show a first possible configuration for an application of the previously described light conversion in projection systems;

FIGS. 11A-11D show a variant of FIG. 10;

FIG. 12 shows other variants of the solutions shown in FIGS. 10 and 11;

FIGS. 13A and 13B show an embodiment of the invention in which a beam splitter cube is used;

FIGS. 14, 14A, and 14B show an embodiment of the invention in which a filter/conversion wheel is used; and

FIGS. 15, 15A, and 15B show a variant of FIG. 14.

### DETAILED DESCRIPTION

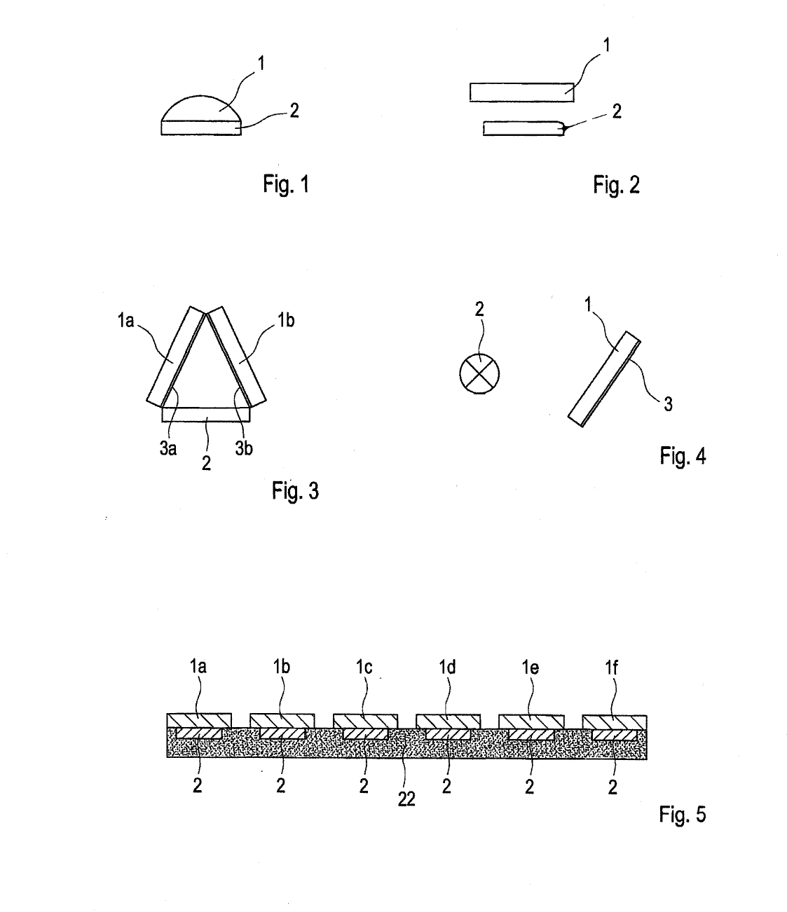

To explain the principle forming the basis of the invention, FIG. 1 shows an arrangement in which an excitation element 2 is in direct physical contact in an emission element 1, whereby emission element 1 has a light-converting material, therefore a so-called phosphor. Excitation element 2 can be, for example, an LED or OLED, which emits optical radiation in the visible blue or near ultraviolet spectral range. An example called phosphor. Excitation element 2 can be, for example, an LED or OLED, which emits optical radiation in the visible blue or near ultraviolet spectral range. An example of this is InGaN LEDs, which emit blue light. The light-converting material of emission element 1, depending on the desired wavelength range, can be a cerium- or europium-doped YAG crystal or a copper- and aluminum-doped zinc sulfide crystal, as a result of which after optical excitation by excitation element 2 the emission of optical radiation is made possible in the spectral range of the three primary colors.

Another variant is shown in FIG. 2 in which emission element 1 is formed at a distance from excitation element 2. The shown structural form has the advantage that by this measure emission element 1 is not heated by excitation element 2 to the same extent as in the variant shown in FIG. 1. Heating of emission element 1 can lead to deterioration of the properties of emission element 1 up to its destruction. The embodiment shown in FIG. 2 thereby lends itself especially for the cases in which a quantum dot material is used for emission element 1, because such materials react especially sensitively to increases in temperature.

A variant is shown in FIG. 3 in which two emission elements 1a and 1b are produced from different materials and therefore emit optical radiations in different wavelength ranges. The excitation of both emission elements 1a and 1b occurs via the common excitation element 2 formed as an LED. Dielectric mirrors 3a and 3b, whose reflection peak is within the range of the emission wavelength of emission elements 1a and 1b, are arranged in each case on the sides of emission elements 1a and 1b facing LED 2. The reflection peak of mirror 3b is within the same wavelength range as the emission wavelength of emission element 1b, whereas the reflection peak of dielectric mirror 3a is within the same wavelength range as the emission wavelength of emission element 1a. Optical radiation, which emerges from LED 2, because of the narrowband reflection characteristics of dielectric mirrors 3a and 3b passes through these virtually unattenuated and excites the materials of emission elements 1a or 1b to produce spectrally narrowband emission. Because of dielectric mirrors 3a, 3b, the two emission elements 1a and 1b emit substantially normal to their surface, on the one hand, directly and, on the other, the excited radiation reflected to a dielectric mirror 3a or 3b. As a result, a good effectiveness of the arrangement shown in FIG. 3 is assured.

FIG. 4 shows a variant to FIG. 3, in which excitation element 2 is arranged in the manner that the optical radiation emerging from it falls directly on emission element 1 arranged at a distance from it. A dielectric mirror 3, which can function like dielectric mirrors 3a and 3b of FIG. 4, is arranged in turn on the side, facing away from excitation element 2, of emission element 1.

FIG. 5 shows an arrangement of six different emission elements 1a to 1f on a common substrate 22. Excitation elements 2, which are formed as LEDs and can have an identical configuration, are located in each case below emission elements 1a to 1f. Because of the different selection of material for emission elements 1a to 1f, each individual emission element 1a to 1f after its excitation by excitation element 2, assigned to it, emits a narrow band in its own spectral range. Thus, for example, the two emission elements 1a and 1b can both emit in the visible red spectral range, but each in a narrow band in spectral lines different from one another. This can also apply to the two emission elements 1c and 1d (green spectral range) and 1e and 1f (blue spectral range). It is particularly advantageous here that this enables the solution, shown in FIG. 5, of arranging light sources with clearly different emission characteristics in close physical proximity on the same substrate. The arrangement shown in FIG. 5 can be produced in a simple way with established semiconductor technology processes.

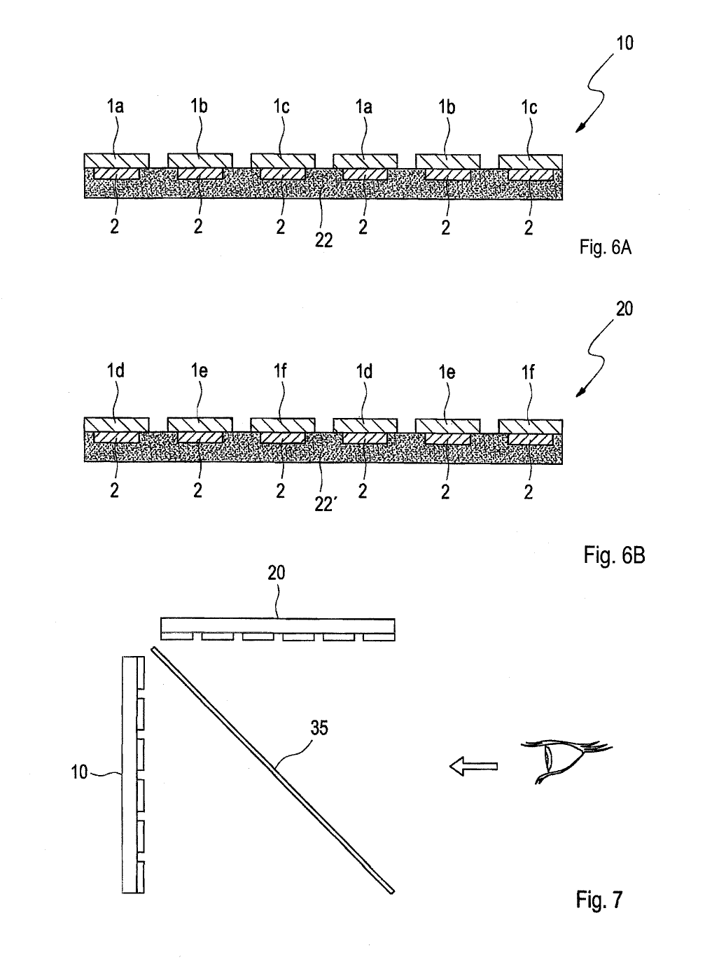

An exemplary use of the solutions presented in FIGS. 1 to 5 for realizing a display device for displaying 3D stereo images is shown in FIG. 6. The first display 10, shown in partial FIG. 6a, shows a substrate 22 with a plurality of LEDs, arranged on substrate 22, as excitation elements and emission elements 1a, 1b and 1c, each assigned to LEDs 2. Three different classes of emission elements are present here on substrate 22, whereby 1a emits in a narrow band in the red visible wavelength range, 1b also in a narrow band in the green visible wavelength range, and 1c in a narrow band in the blue visible spectral range.

The second display 20 shown in FIG. 6b corresponds in its structure substantially to display 10 shown in FIG. 6a and particularly substrate 22′ can be provided with LEDs as excitation elements 2, which are made identical to excitation elements 2 shown in FIG. 6a. Emission elements 1d, 1e, and 1f, which are arranged on display 20, in fact emit also in the visible red, green, and blue spectral range, but in each case with an emission spectrum different from emission elements 1a to 1c of FIG. 6a. For the purpose of simplification, the notation R1, G1, B1 will be used below for the emitted radiation of emission elements 1a-c of FIG. 6a and R2, G2, B2 for the emitted radiation of emission elements 1a-f of FIG. 6b.

In the examples shown in FIGS. 5 and 6, all spectrally narrowband emissions are excited by light conversion. It is also conceivable in addition to use the radiation emitted by the radiation elements for a primary color, for example, to replace one or both of the emission elements for the primary color “blue” directly by the excitation element and to generate thereby one or both narrowband emissions in the blue spectral range directly, i.e., without light conversion.

To form a display device, as shown in FIG. 7, now the two displays 10 and 20 of FIG. 6a or 6b, respectively, are arranged at a right angle to one another. Dichroic mirror 35 as an optical superposition unit is arranged on the angle bisector between the two displays 10 and 20, said mirror which, for example, is highly reflective for the optical radiation emerging from display 20, but transparent for the radiation emerging from display 10. A superposition of the two images shown on display 10 or 20 can be achieved in this way in the illustrated viewing direction. A three-dimensional image impression in the viewing direction can now be achieved in that a viewer wears glasses whose right lens is provided with interference filters which are matched in their spectral characteristics to the emission characteristics of display 20. In other words, the interference filter assigned to the right eye allows the optical radiation emitted by display 20 to pass through totally or partially, but blocks the optical radiation emitted by display 10. Conversely, the interference filter assigned to the left eye of the viewer blocks the radiation emitted by display 20, but allows the radiation emitted by display 10 to pass through also totally or partially. If now the right partial image of a stereo image is shown on display 20 and the left partial image on display 10, then the viewer has a spatial impression because of the interaction of the emission characteristics of the two displays 10 and 20 and the different transmission characteristics of the interference filters in front of his eyes.

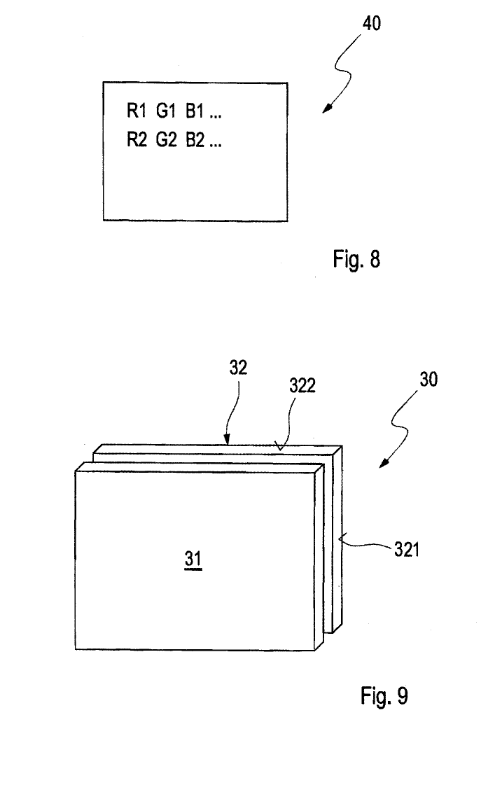

The superposition of the two partial images for generating a spatial impression can also be achieved in that, as shown in FIG. 8, emission elements 1 for all spectral lines R1, G1, B1 and R2, G2, B2 are arranged on a common substrate 40. In the case shown in FIG. 8, the superposition of both partial images for the right and left eye occurs directly on the substrate on which excitation elements 2 and emission elements 1 are arranged. The variant shown in FIG. 8 is suitable particularly for realizing a 1-chip microdisplay.

An advantage of the technology of 3D image generation, shown in FIGS. 6-8, is that the necessary narrowband optical radiation, employed for imaging, because of the at least partial use of light-converting materials, can be generated in principle without the use of spectral filters such as, for example, interference filters. Conventional 3D image generation, in which the aforementioned interference filter technology is used, uses relatively broadband light sources and generates the partial images, necessary for three-dimensional imaging, by transmission of spectrally narrowband partial ranges, for example, by interference filters. On the one hand, however, intensity is lost in this way, and, on the other, it is necessary to collimate the optical radiation emitted by the broadband light source before its incidence on the interference filter in a relatively narrow angle range, in order to prevent spectral shifts and thereby crosstalk of the partial images between one another.

In contrast to this, in the present case the narrowband optical radiation is generated not by filtering but by light conversion, so that thereby the above-described problem does not occur or is greatly reduced. It is conceivable, however, to use additional filters, especially interference filters, to improve the spectral purity of the employed radiation.

A variant, in which both partial images can be displayed simultaneously, was presented in FIGS. 6-8.

Also possible, however, are variants in which the partial images and/or also the particular spectral sections of the partial images are generated sequentially one after the other and because of the inertia of the eye a color three-dimensional image impression results nevertheless. An embodiment of the invention, which is based on this principle, is shown in FIG. 9.

FIG. 9 shows schematically an LCD display 30, in which another variant of the invention is employed. In this case, an LCD matrix 31 is lighted from the back with light, which has the spectral properties already described above and is necessary to generate a three-dimensional image impression. The light source emits the 6 spectral ranges R1, G1, B1 and R2, G2, B2 necessary to achieve an overall color impression. The spectral ranges R1, G1, B1 in this case are assigned, for example, to the left eye and the spectral ranges R2, G2, B2 to the right eye. Each partial image is then assigned the associated configuration of the light valve of the matrix by the correspondingly synchronized control of the LCD matrix, so that in the present example the partial image for the left eye is shown by the LCD matrix when the light source emits in at least one or all of the 3 spectral ranges R1, G1, or B1. The same applies to the partial image for the right eye. Because an emission element, which is excited by an excitation element to emit narrowband optical radiation, is used for backlighting in at least one of the spectral ranges, the possibility arises of omitting the use of additional optical filters; as a result, on the one hand, the problem already described above in regard to geometric incidence conditions and loss of intensity can be countered and, on the other, because of the smaller required installation space, improved structural options result for realizing a compact 3D-capable LCD display. As has already been mentioned, the backlighting can also occur in that different methods are used to generate the optical narrowband radiation for the particular spectral ranges. Thus, for example, on the one hand the narrowband optical output radiation of the laser can be used directly for image generation in a spectral range; on the other hand, spectrally narrowband radiation in another spectral range can be generated by means of light conversion from the laser radiation. In addition, the necessary narrowband radiation can also be generated by filtering, for example, by means of interference filters from broadband output radiation. A homogeneous illumination of LCD matrix 31 in the shown example is achieved by coupling the light used for backlighting into a flat light guide 32 which is arranged behind the LCD matrix and from which it again emerges uniformly over the entire surface of the LCD matrix. The coupling into light guide 32 can be done via side surfaces 322 or 321 or also the side surfaces that are not labeled and lie opposite to these surfaces, separately or in any combinations; in this case, the side surfaces can be coated completely or partially with a light-converting material, as a result of which emission elements are formed within the meaning of the present invention. Coating of those areas of light guide 32 from which the light emerges for backlighting of the LCD matrix is also conceivable. Moreover, light conversion can also occur in the material of the light guide itself over the volume of the light guide. The light guide need not necessarily be configured as a single piece as illustrated; division into row- or column-shaped segments is possible, apart from a matrix-like structural shape. In the shown example, light guide 32 is used for backlighting in all employed spectral ranges; similarly, a plurality of light guides arranged one behind the other can be present for backlighting in different spectral ranges. In this case, the light guides can be coated with the appropriate light-converting materials on their in-coupling sides or on their out-coupling sides. Thus, e.g., two cuboid light guides, arranged one behind the other and separated by an air gap, are used, which are coated with a light-converting material on their out-coupling side (therefore the side facing the LCD matrix). In addition, two wedge-shaped light guides can be used, which are arranged separated by an air gap so that together they again produce a cube shape. In this case, coating of the in-coupling side of the light guides is an option, therefore in each case the sides opposite to the wedge tip.

Direct backlighting of the display by emission or excitation elements, distributed optionally in the form of a matrix, is also conceivable.

The invention may also be used for generating a three-dimensional image impression by means of a projection method. There is a possibility in this regard to generate partial images in different spectral ranges in rapid succession one after the other by means of a so-called color wheel. A projection system, which is based on this principle, is disclosed in German Offenlegungsschrift No. DE 102 49 815 A1. To this end, first the partial images of an image to be projected is generated on an imaging unit, lighted by means of a light source, such as, e.g., DLP chip, and then projected by means of an imaging unit on a projection screen, for example, a canvas.

The rotating color wheel, which contains at least two different sectors to generate the individual spectral components of the partial images, is arranged in the light path between the light source and the projection screen, for example, between the light source and the imaging unit. In contrast to the color wheel shown in the aforementioned German Offenlegungsschrift and formed as a filter wheel, according to the invention at least one sector of the color wheel is provided with a light-converting material, which after excitation by an excitation element exhibits a spectrally narrowband emission, as a result of which this sector of the color wheel functions as an emission element within the meaning of the present invention. As already set forth above, in this case as well it is not absolutely necessary to generate all spectral ranges employed for image generation by light conversion; combination forms are also conceivable with the use of a color wheel, particularly in combination with optically narrowband excitation. For example, a color wheel may contain 6 sectors, 5 of which are formed as interference filters for the spectral ranges G1, G2, B1, R1, and R2, and whereby another sector is coated with a light-converting material, which emits as a narrow band in the blue region (B2) during blue excitation radiation (B1). During use of a blue laser as an additional light source, the blue spectral range could be addressed in this way by the excitation radiation B1 of the laser and the emitted radiation of the light-converting material B2. To achieve a clean separation of the two blue spectral partial ranges B1 and B2, it is advantageous to provide the color wheel sector that has the light-converting material in addition with a dichroic mirror, which only allows the portion B2 emitted by the light-converting material to pass through. In addition, the dichroic mirror can be selected so that it also blocks the side bands of the emission excited in the light-converting material in order to largely suppress crosstalk between the individual partial images. Variants are also conceivable in which the dichroic mirror allows the excitation light to pass through and reflects the light emitted by the light-converting material.

A number of exemplary embodiments of the invention for projection systems will be explained below using the additional figures; in this case, initially variants without a color wheel will also be addressed.

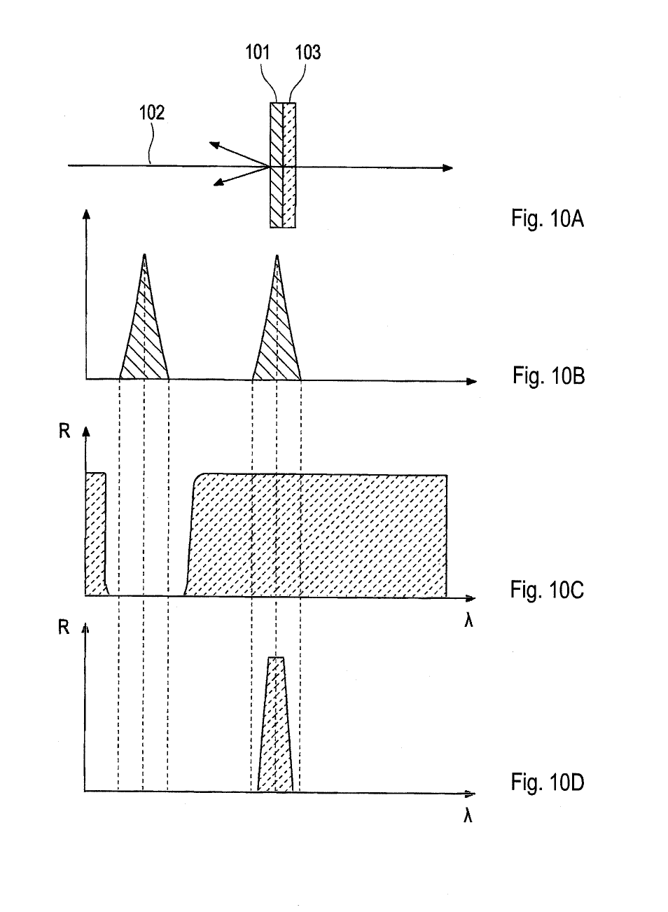

FIG. 10 shows a first possible configuration for use of the previously described light conversion in projection systems.

In this case, excitation light 102 hits emission element 101, whose back side has a dichroic mirror 103, as is evident from FIG. 10a. The spectral distribution of excitation light 102 and of the light emitted as a result of the excitation is illustrated in FIG. 10b; in this case, the left peak indicates excitation light 102 and the right peak the emitted light obtained by light conversion. Possible reflection properties of dichroic mirror 103 are shown in FIGS. 10c and 10d; in this case, the reflectivity of the dichroic mirror in each case is plotted versus wavelength λ. As is evident from FIG. 10c, in the first variant the reflectivity of dichroic mirror 103 is high over the entire range of wavelengths of the emitted light and low in the entire range of the excitation light; i.e., dichroic mirror 103 is virtually transparent for excitation light 102, so that the non-converted portions of excitation light 102 can pass virtually without deflection through dichroic mirror 103. The converted portions of excitation light 102 are reflected at the dichroic mirror, however, as indicated by the unlabeled arrow in FIG. 10a. FIG. 10d shows a variant in which the reflectivity of dichroic mirror 103 is high only in a sub-range of the spectral bandwidth of the emitted light, so that dichroic mirror 103 functions as a narrowband filter for the emitted light (in reflection) and as a result the spectral width of the emitted and subsequently reflected light is reduced.

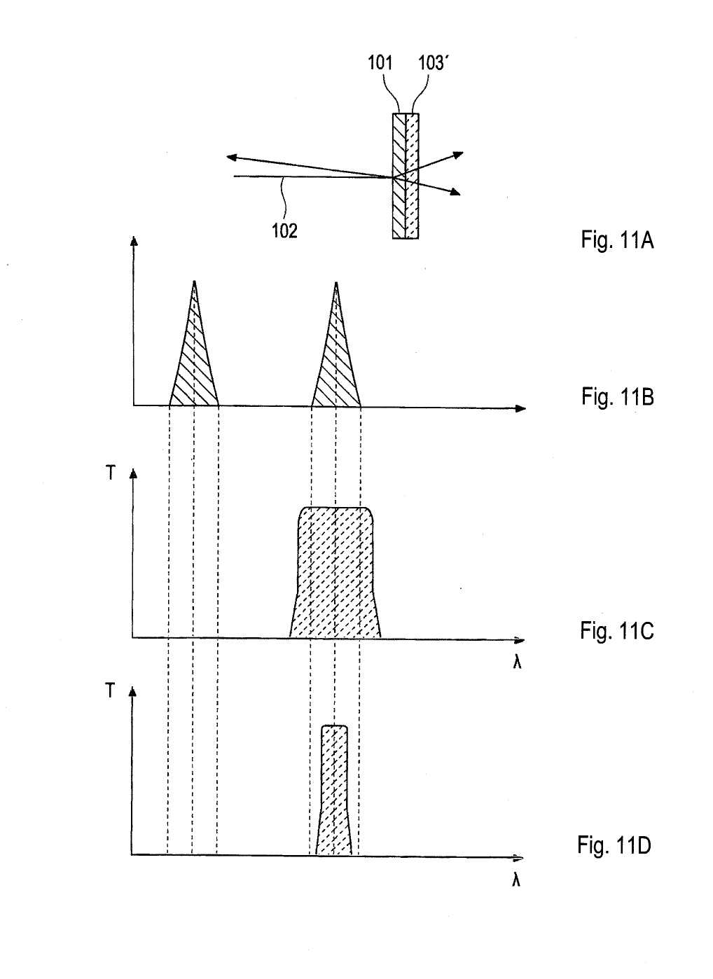

FIG. 11 shows a variant in which dichroic mirror 103′ transmits the emitted light either completely or partially and reflects excitation light 102. The associated transmission properties of dichroic mirror 103′ are shown qualitatively in FIGS. 11c and 11d as transmittance versus wavelength. FIG. 11b shows the spectral distribution of the excitation light and of the emitted light and corresponds substantially to the illustration already shown in FIG. 10b. As is evident from FIG. 11a, in the present case the emitted light passes through mirror 103′ either in its full spectral width (cf. FIG. 11c) or after another spectral filtering through dichroic mirror 103′, as shown in FIG. 11d. Excitation light 102 in each of the cases shown in FIGS. 11c and 11d is completely reflected back by dichroic mirror 103′. The clipping of the spectral edges, as shown in FIG. 11d, is necessary when the emitted light has a too large spectral width for use in 3D visualization.

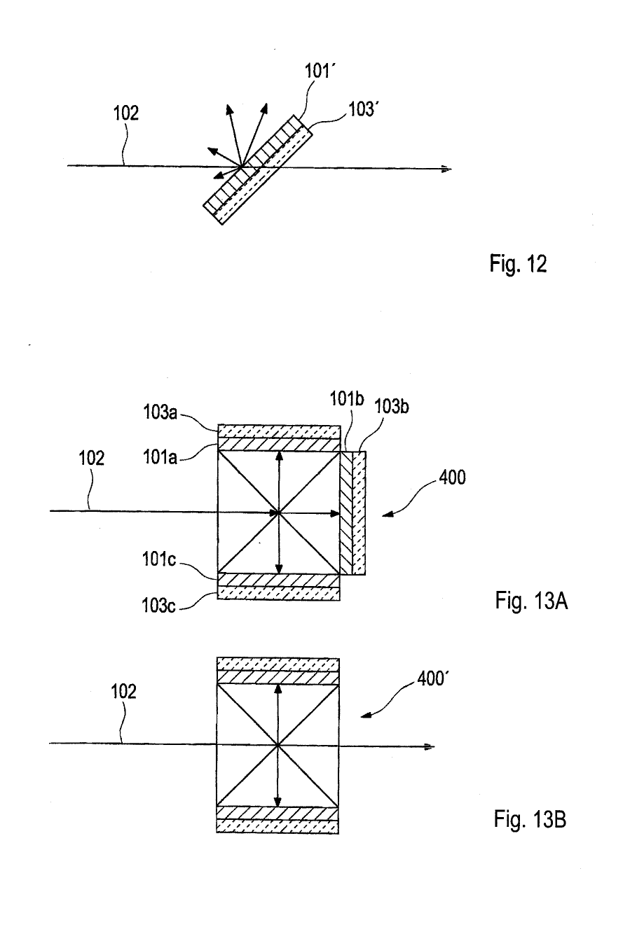

FIG. 12 shows another variant of the solutions shown in FIGS. 10 and 11 with an orientation of dichroic mirror 103′ and emission element 101′, tilted relative to the direction of excitation light 102.

FIG. 13 shows an embodiment of the invention, in which a beam splitter cube 400 or 400′ is used. Excitation light 102 in this case is split into three sub-beams. In the example shown in FIG. 13a, each of the formed sub-beams (indicated by the arrows) hits an emission element 101a, 101b, and 101c, behind which there is a dichroic mirror 103a, 103b, and 103c. The dichroic mirror in this case can act as described in the previous FIGS. 10 to 12. A variant is shown in partial FIG. 13b, in which the non-deflected portion of excitation light 102 passes beam splitter cube 400′ unconverted, whereas the deflected portions of excitation light 102 are supplied to emission elements 101a or 101b and dichroic mirrors 103a or 103b as in FIG. 13a.

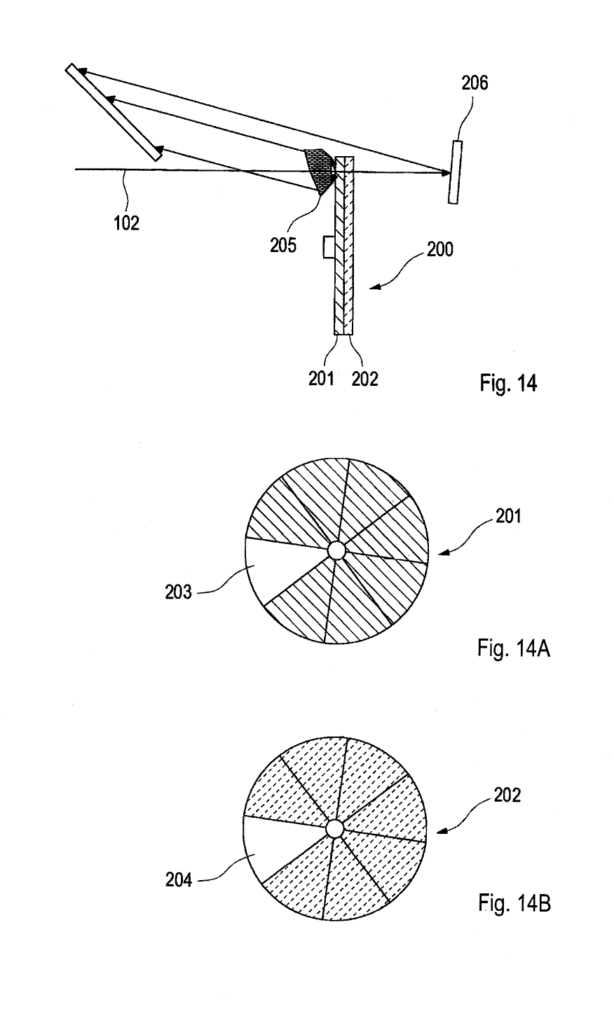

FIG. 14 shows an embodiment of the invention in which a filter/conversion wheel 200 is used; in this case, the filter/conversion wheel 200 shows the two partial discs 201 and 202 arranged one behind the other, which are shown in partial FIGS. 14a and 14b in a plan view. Partial disc 201, which can also be called a conversion disc, contains a plurality of segments of different emission elements and a chromatically neutral segment 203, which is substantially transparent to excitation light 102. Likewise, disc 202, which can also be called a filter disk, contains a plurality of segments with dichroic mirrors and also a neutral segment 204 transparent to the excitation light. During operation of filter/conversion wheel 200, the two neutral segments 204 and 203 are superimposed and the filter/conversion wheel 200 is rotated. As shown in FIG. 14, for example excitation light 102, generated by a laser, passes through optics 205 and hits filter/conversion wheel 200, where depending on the position of wheel 200 it is converted or allowed to pass through. The converted light in this case is reflected at partial disk 202 and leaves the region of filter/conversion wheel 200 in the direction of optic element 205, which performs a parallelization of the converted light. In the case in which the transparent or chromatically neutral segment 203 and 204 is located in the light path, filter/conversion wheel 200 passes through and excitation light 102 hits mirror 206, which reflects excitation light 102 in the direction of the converted light, so that the excitation light as well can be used for image generation in a 3D stereo projection system.

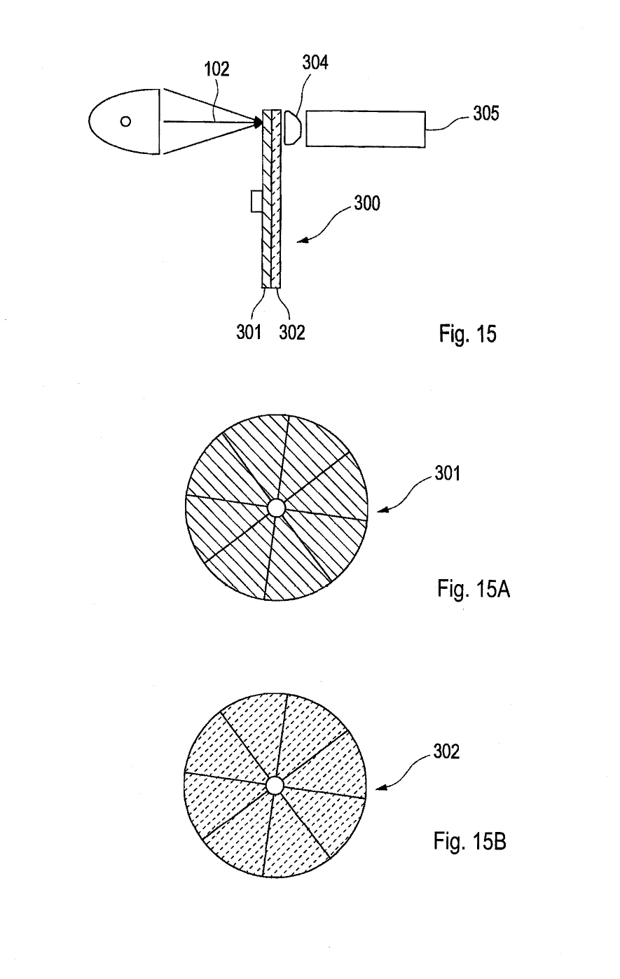

FIG. 15 shows a variant to FIG. 14, in which excitation light 102 is converted in each case; consequently partial discs 301 and 303 also have no transparent or optically neutral segments, as shown in FIG. 15a or 15b. As shown in FIG. 15, excitation light 102 is focused and hits filter wheel 300, where the conversion and filtering of the emitted light occurs in the already described manner. After passing through collimation lens 304 and homogenizer 305, the converted light is available for purposes of 3D projection. The shown example concerns an RGB system with an additional secondary color or white, which results in the eight segments of the filter wheel or a conversion wheel 300. An adjustment to the spectral dependence of the sensitivity of the eye or to different emitted intensities can be made by the shown different angle sections of the individual segments.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A display device for displaying stereoscopic images, the device comprising:
narrowband emitting emission elements adapted for image generation; and
a plurality of different emission elements, at least one of which contains a light-converting material excited by an excitation element for emitting optical radiation, the plurality of different emission elements being configured to generate spectrally narrowband optical radiation in different spectral ranges,
wherein partial stereoscopic images are generated in spectral ranges at least partially different from one another.

2. The display device according to claim 1, wherein the emission elements are formed at least partially as pixels or subpixels of a display.

3. The display device according to claim 2, wherein the display device has at least one substrate with a plurality of LEDs arranged on the substrate and at least one part of the emission elements assigned to the LEDs, wherein narrowband optical radiation in the visible blue, visible green, and visible red spectral ranges is emitted by the pixels or subpixels, and wherein there are two emission bands for each of the mentioned spectral ranges.

4. The display device according to claim 3, wherein the pixels or subpixels are arranged on different substrates, and wherein the pixel images arising on the substrates are superimposed via an optical superposition unit.

5. The display device according to claim 1, further comprising a projection unit configured to generate an image, wherein at least one emission element is arranged on a color wheel.

6. The display device according to claim 1, wherein the display device is an LCD display, and wherein at least one part of the emission elements is formed as part of a lighting unit for backlighting the LCD display.

7. The display device according to claim 6, wherein the emission element is arranged on an entry or exit surface of a light guide.

8. The display device according to claim 1, wherein at least two different emission elements are assigned substantially similar excitation elements for optical excitation of the emission elements.

9. The display device according to claim 1, wherein the excitation elements emit optical radiation to excite the optical emission elements.

10. The display device according to claim 9, wherein at least one excitation element emits optical radiation of a shorter wavelength than the emission element.

11. The display device according to claim 1, wherein at least one emission element contains a nanomaterial.

12. The display device according to claim 11, wherein the nanomaterial contains quantum dot nanoparticles.

13. The display device according to claim 1, wherein the excitation element and the emission element are in direct contact.

14. The display device according to claim 1, wherein the excitation element and the emission element are arranged at a distance from one another.

15. The display device according to claim 1, wherein the emission element is arranged on a dichroic mirror.

16. The display device according to claim 15, wherein the mirror is configured to transmit the light emitted by the excitation elements and reflects the light emitted by the emission elements.

17. The display device according to claim 15, wherein the mirror reflects the light emitted by the excitation elements and transmits the light emitted by the emission elements.
